(19) United States
(12) Patent Application Publication
(10) Pub. No.: US 2023/0316200 A1
(43) Pub. Date: Oct. 5, 2023

(54) Computer-Implemented Effect and Uncertainty - Specification, Design and Control

(71) Applicant: MITRE Corporation, McLean, VA (US)

(72) Inventors: Saurabh Mittal, McLean, VA (US); Rob Wittman, Jr., McLean, VA (US); David L. Prochnow, McLean, VA (US)

(21) Appl. No.: 17/713,842

(22) Filed: Apr. 5, 2022

(51) Int. Cl. G06Q 10/06; G06Q 10/04

(52) U.S. Cl. CPC G06Q 10/06375; G06Q 10/06315; G06Q 10/04

(57) ABSTRACT

Contextual data is received and processed that characterizes a current state of people, processes, and technology resources of an entity. In addition, data comprising desired adversarial effects against the entity and received and processed. A computer-implemented effect and uncertainty strategy application programming interface (API) generates an effect-web plan the based on the contextual data and desired effects requirements. The effect-web plan includes a plurality of effects, actions and task plans to implement the desired adversarial effects. Thereafter, available human-machine team-systems to execute the effect-web plan are determined. The generated effect-web plan can be deployed by multiple selected team-systems. Data characterizing a multi-order impact of the deployment of the effect-web plan on the entity can be monitored. The generated effect-web plan can be modified and deployed based on the monitoring so as to increase a likelihood of an occurrence and success of the desired adversarial effects. Related apparatus, systems, techniques, and articles are also described.

### TECHNICAL FIELD

The subject matter described herein relates to computer-implemented techniques and specification for an Effect and Uncertainty Planning and Control System (EUPCS) for selectively configuring constrained resource systems in a modular team-system to produce one or more effects for increasing uncertainty so as to degrade a competitor's ability to gauge its own performance in a shared environment.

### BACKGROUND

Increasing amounts of information about companies and other organizations and entities are available online and via various data feeds (including proprietary data feeds). This information can characterize the operations of such companies and other organizations and entities (e.g., competitors, opposing military, etc.) including historical actions and performance as well as projected future performance.

### SUMMARY

In a first aspect, contextual data is received and processed that characterizes a current state of people, processes, and technology resources of an entity in a competitive (adversarial) zero-sum environment. In addition, data comprising desired adversarial effects against the competitor is received and processed. A computer-implemented effect and uncertainty strategy application programming interface (API) generates an effect-web plan based on the contextual data and uncertainty strategic goals. The effect-web plan includes a plurality of effects, actions and task plans to implement the desired adversarial effects. Thereafter, available team-systems to execute the effect-web plan are determined, with a team-system being a System of Systems (SoS) such as one or more of information gatherer systems, networking communication systems, and performer systems. The generated effect-web plan can be deployed by a selected team-system (e.g., a top ranked team-system, etc.) to a shared marketplace, either simulated or real. The objective of an effect-web plan is to impede the entity's ability to gauge its own performance. Such impediments can be achieved by the actions of the top-ranked team-system through a controlled effect-web. Data characterizing a multi-order impact of the deployment of the effect-web plan on the entity can be monitored to provide evidence of the efficacy of the effects in degrading an entity's ability to gauge its own performance (as gathered from the effect-specific contextual data). The generated effect-web plan can be modified and deployed based on the monitoring of contextual data so as to increase a likelihood of an occurrence and success of the desired adversarial effects.

In another aspect, an identified entity is selected for gathering contextual data that characterizes a current situation of people, processes, and technology resources of the entity. Contextual data can characterize different situation contexts. A situation context is a set of considerations (variables) that formulates a state of a given entity (e.g., competitor entity, etc.). A situation context has a spatiotemporal character, i.e., the variables defining a situation have a geolocation and timestamp. Data is received for the situation context that includes or otherwise specifies a desired adversarial effect against the entity. Thereafter, based on the contextual data, a computational engine iteratively generates a plurality of plausible effects, team-systems to generate the effects, and action (plans) to utilize a limited set of available resources from a resource pool registry (via an API) to implement the one or more desired adversarial effects. The plans are later imposed/deployed in a simulated or real environment. The plurality of effects, team-systems and actions plans is referred to herein as an effect-web plan.

An effect as provided herein is a concept implemented as a complex variable that associates an action and its multi-model impact on various entity variables organized as situation contexts.

The team-systems can comprise different components (or systems) such as an ensemble of one or more information gatherer systems, network builder systems and performer systems. Unless otherwise specified, the team-systems can include human, machine, or human-machine combinations. A team-system can be a system of system (SoS). An SoS is an architectural construct that provides a common purpose to a group of constituent systems. These constituent systems can be managed independently, operated independently, evolve independently, geographically separated by a distance, connected by communication networks and result in a collective emergent behavior, termed as “effect” of an SoS function. SoS taxonomy includes four types of SoS: (1) Virtual SoS: no control and no functional alignment by design, (2) Collaborative SoS: no central control but agreed management and functional alignment, (3) Acknowledged SoS: no central control but recognized overall functional effect, and (4) Directed SoS: central control and overall functional effect but retaining operational independence. The team-system to be designed here belongs to the Acknowledged SoS category.

The generated effect-web plan can be deployed as part of a computer-implemented simulation.

The available team-systems can be determined using a multi-objective constraint optimization algorithm and/or by one or more machine learning models.

Data that characterizes the multi-order impact of the effects on the entity can be monitored through an information gatherer API. This monitored effect-specific data, along with the contextual data (stored within the system or from a simulated environment), can be used by a machine learned-based decision engine as part of the iterative effect-web plan generation.

Multiple information gatherer systems (sensing platforms or data feeds or simulated data) can be deployed to obtain the contextual data. One or more of the sensors, in some implementations, are software-based and configured to obtain data and synthesize context from differing data sources. Synthesizing context requires consolidating entity state variables and their deviations from the desired uncertainty goals. In addition or in the alternative, one or more of the sensors can be a hardware-based sensor including a processor and memory. The sensors, in some variations, can also provide the monitored data.

The received contextual data can be categorized as competitor state variables. To influence a subset of the competitor state variables, end-state variables can be identified. The goal of the EUPCS system is to cause one or more of the end state variables to change over time to impact an entity's performance in a negative manner. With this information, game theory can be applied to specify one or more computer-implemented identified actions to evaluate the end-state variables operating within a pre-defined range.

Causing the generated effect-web plan to be executed can include defining a team-system configuration from the available system resources within the resource pool (accessible via a resource market API) to execute each effect. The team-system can include one or more of: information gatherer systems, performer systems or network builder systems that collectively act to deliver effects in a shared marketplace in simulated or real environment (via sending commands to either a simulation API or an external system API).

Constraints applicable to the information gatherer systems, performer systems, and/or network builder systems can be iteratively matched within the team-system configuration to formulate new tasks and schedules to deploy the team-system configuration for producing effects defined within the effect-web in the shared marketplace (simulated or real).

Control on uncertainty associated with end-state variables can be established. This control can provide that at least one of the identified effects within the effect-web targets the competitor state variables which have the associated uncertainty in an operating range of the competitor state variables.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating components forming part of an Effect and Uncertainty Planning and Control System (EUPCS);

FIG. 2 is a first diagram illustrating an effect and requirement specification system;

FIG. 3 is a diagram illustrating an effect and uncertainty design algorithm;

FIG. 4 is a diagram illustrating an effect and uncertainty control system;

FIG. 5 is a process flow diagram for implementing effect and uncertainty strategy; and

FIG. 6 is a diagram of a computing device for implementing aspects directed to uncertainty control.

### DETAILED DESCRIPTION

The current subject matter is directed to advanced computer-implemented techniques and computing architectures for instituting effect-web plans by an entity A, also known as EUPCS “owner” for an entity B. Entity B, can for example, be A's business competitor or other form of adversary. The effect-web plans can result in a desired adversarial effect or result such as increasing uncertainty and confusion for the entity B to disrupt B's normal state or a decrease in gauging B's own performance in a shared marketplace. A shared marketplace, as provided herein, is an environment in which performer systems, network builder systems and information gatherer systems exchange information, goods and services in a zero-sum game for incentives such as an increase in geographical territory or increased number of consumers of information, goods and services. Examples of a shared marketplace include business markets for incentives of greater product penetration, social media for incentives such as dominant narratives, or military battlespace with incentives such as capture of adversary territory.

As used herein, the term “owner” (entity A) can refer to the initiator of the algorithms provided herein in relation to one or more competitors. The term “competitor state variable” (CoSV) can refer to a variable that corresponds to some aspect of an entity B's overall state or a state that pertains to a particular issue, circumstance, people, process and/or technology. The term “range of CoSV” can refer to the operating range of the variable. Range of CoSV can be either qualitative or quantitative but not both. A qualitative range is a Boolean state (true/false encoded as 1 or 0). A quantitative range can be bounded within two thresholds: [lowerbound, upperbound], encoded as a floating-point number. The term “end state variable” (EnSV) can refer to a subset of CoSV that the owner intends to influence and has the technology and the means to do so. The owner typically has incomplete information about the corresponding CoSV operating range. Uncertainty of CoSV can refer to the difference between the bounded ranges of EnSV and CoSV variables. “Game theory strategies” can refer to the owner contextualizing competitor response per a library of game theory strategies such as Tit for Tat, Tit for 2 Tats, and many others. “Competitor state” CoSV for owner's use and targeted influence can be termed as a set of EnSVs. “Effect” can refer to a set of EnSVs that the owner can influence, instrument, and monitor in a spatiotemporal manner by its actions. Effect can be qualitatively denoted by: <no effect, partially effective or fully effective> and quantitatively denoted by Effect_n_i_score, where n_i is the i^{th} effect in a set of n effects. “Effect-Web” can refer to a set of effects with spatiotemporal characteristics. “Effect-Web state” can refer to an effect-web caused by the owner and can qualitatively result in: <no effect, partially effective or fully effective> and be quantitatively expressed as effect web score. “Network builders systems” can comprise a set of systems that provide communication and control mechanisms to influence EnSVs. “Performer systems” can refer to a set of systems that produce an effect to indirectly influence EnSV ranges and uncertainty score. “Information gatherer systems” can refer to a set of systems that provide instrumentation (data feeds) to monitor EnSVs. “Action” can refer to an act that may be taken by a performer system to produce an effect. “Task” can refer to an action that is scheduled for a performer system in the future. “Team-system” can refer to a configuration of information gatherer systems, performer systems and network builder systems that collectively, as an Acknowledged SoS, act to deliver an effect.

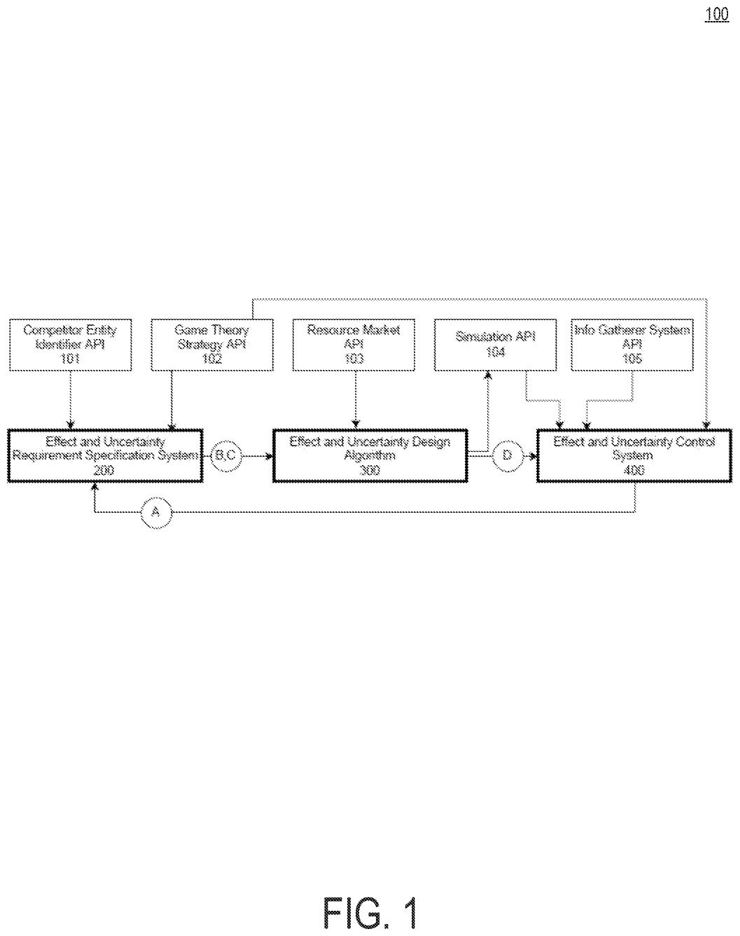

FIG. 1 is a diagram 100 illustrating a top view of the architecture of EUPCS in which various computing devices/computing device clusters 200, 300 and 400 may interact over a communication network (radio or software) depicted as used in A-D. Device 200 is an example of a requirement specification system for EUPCS. Device 300 is an example of system to implement a design algorithm, which in turn, implements the specified requirements to generate an effect-web plan. Effect and Uncertainty Control System is a device 400 that maintains control over effect-web and evaluates perceived competitor performance and takes corrective action for maintaining the structure of the effect-web. These computing devices 200-400 exchange data from various application programing interfaces (APIs) (101-105) that are either connected to live or simulated systems. Competitor identifier API (101) provides data about various competitor entities that are targeted by the EUPCS system. Game theory strategy API (102) provides information about strategies that define various actions within the effect-web plan. Resource market API (103) provides information about various resource systems (e.g., information gatherer systems, network builder systems and performer systems) that can be used to deliver effects and procure additional data for the entity's state.

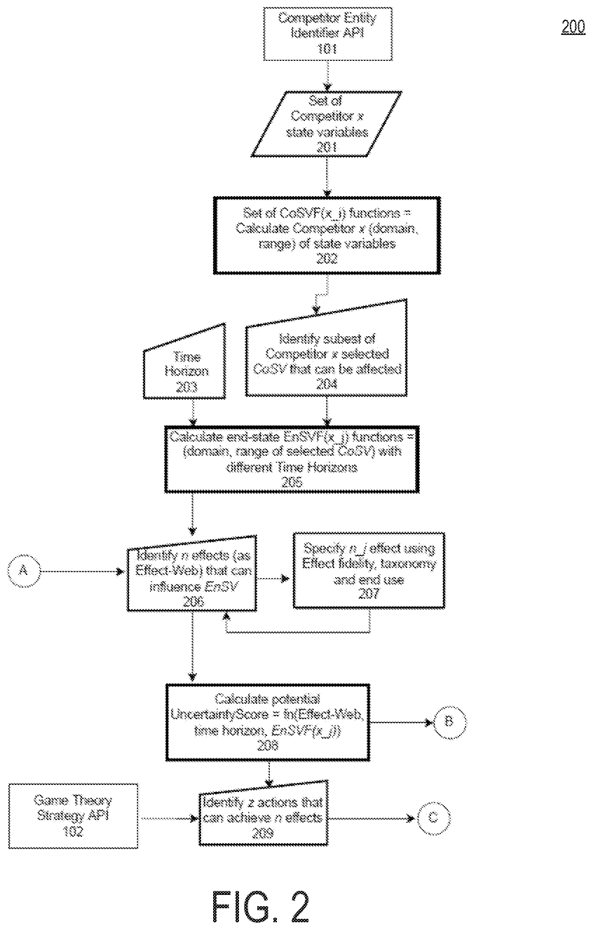

FIG. 2 is a diagram 200 illustrating the architecture and aspects for specifying requirements for a desired effect-web plan for at least one entity (e.g., competitor entity, etc.). Initially, at 201, a set of entity state variables (CoSV) are identified for a specific entity, which is notified through the competitor identifier API 101. These variables provide information about some aspect of an entity's overall state, such as geolocation of critical functional assets, vulnerability of such assets to get compromised, number of assets, modality of assets and/or temporal behavior of assets. An asset is something of “value” to an entity, for example, a physical facility, a technology, personnel, product, etc.

A subset of variables in 201 is further analyzed for their domain and range values in 202 to arrive at a set of mathematical functions CoSV(x_i) that identifies relationship between domain and range values, where x denotes a competitor x and i denotes a CoSV from a set of CoSVs for competitor x. A domain of CoSV(x_i) is the set of values for which the function CoSV(x_i) is defined. For example, let there be a competitor or adversary with a radar asset that has a maximum range of detection of 100 miles and is protected by munitions that can counterattack. A radar for an adversary is a competitor asset that provides deterrence. Let CoSVx_1=range of radar detection and CoSVx_2 be the number of munitions for counterattack are the two CoSVs. Let the known maximum value of CoSVx_1 be 100 miles and the maximum value of CoSVx_2 be 70. Accordingly, function CoSVF(x,1) is defined. A function f(x) such as CoSVF(x,1) can be “to decrease the detection range of radar”. Similarly, CoSVF(x,2) can be “reduce the number of munitions”. Further, the domain of CoSVF(x,1) can take the values: (destroy, degrade), that could fulfil the goal of decreasing the detection range. These results can be the two effects that will be requiring planning. Likewise, the domain values for CoSVF(x,2) can take value: (expend at least 90% of munitions). A range of function CoSVF(x,1) is the set of values CoSV(x_i) can take for a given set of domain values. For each of the identified domain values for CoSVF(x,1), viz., the range values for the domain: “destroy” can result in the interval [0,5] miles, and the range values for the domain: “degrade” can result in the interval [0,50] miles. Similarly, the range values for “expend” domain for CoSVF(x,2) can take the values in the interval [0,7]. From this set of CoSVF(x, i) functions, a subset can be manually selected in 204 that the EUPCS has the technology and means to affect. This selection can be based on multiple criteria such as technology, geography, understanding of various competitor variables and timeframes. For the running example, of these two CoSVs, CoSVF(x,1) can be selected for further consideration. Through manual input in 203 that specifies the time horizon to impact a CoSV(x_i) and a manual selection of a subset of j CoSVs from the set of i CoSVs, a set of end-state state variable functions EnSV(x_j) for different time horizons in 205 are defined that EUPCS can affect. For the current example, let the time horizon be in the interval [1,6] hours and EnSV(x,1)=CoSVF(x,1). A function EnSVF(x,1), then, is defined for time horizon tH1=2 hours for (domain, range)=(degrade, [50,100] miles), and another function EnSVF(x,2) is defined for time horizon tH2=5 hours for (domain, range)=(destroy, [0,5] miles). The target EnSVF(x,I) functions are then further reviewed manually in 206 to identify j indirect effects in the shared marketplace that could influence the range values for EnSVF(x) functions. For this example, two effects have now been identified EnSVF(x,1): degrade by Cyber effect and EnSVF(x,2): destroy by kinetic effect. For each of the j effects identified in 206, effects are specified using effect taxonomy, fidelity, and end use aspects. Effect taxonomy includes effect classification such as kinetic effects or non-kinetic effects. Kinetic effects include direct fires or indirect damage by kinetic performer systems. Non-kinetic effects include effects resulting from a cyberattack or electronic attack or disruption in accessibility and communication without any kinetic means such as psychological operations. Effect fidelity can include aspects such as the set of EnSV(x_j) range values, purpose, spatial location time horizon, granularity, duration, geographical size, and number of other EnSVs affected by the effect. For the current example, EnSVFx1(degrade) results in [range=(0, 50), purpose=“disruption”, spatial location=(lat, long), time horizon=2 hr, granularity=“campaign”, duration=1 hr, geographical size=radius of 50 miles, number of other EnSVs affected=0). Effect purpose attribute can include semantic association of effect for a given purpose such as disruption, deactivation, destroying of a competitor resource, suppression, delay, illumination, and enhancement of an existing effect. The specification of all the j effects is then used to calculate an uncertainty risk score in 208, which can be value derived from an aggregate of EnSVF(x,j) functions for different time horizons for the identified j effects. An uncertainty score quantifies the risk associated with achieving an effect within a given time horizon. In one variation, the uncertainty score is the ratio of identified domain range in EnSVFx with the operational maximum value of the CoSVx normalized over the time horizon. For example, as the objective of EUPCS is to degrade competitor's ability to gauge its own performance, the uncertainty score for EnSVFx1(degrade) will be higher than the EnSVFx2(destroy). Consequently, the selection of “degrade” over “destroy” effect will be preferred within the effect-web plan. The uncertainty risk score for the overall effect-web is aggregated from the constituent uncertainty scores of each of the effects and can be further normalized by the number of effects and aims to rank-prioritize and minimize the needed effects. This uncertainty score for each effect and its constituent fidelity attributes are then used in 209 to arrive at various actions (through manual input) that could be performed to produce the effects in a simulated or real environment. For example, for EnSVFx1(degrade), the action selected is cyber-attack, and the EnSVFx2(destroy), the action selected is kinetic strike. The identified set of actions are validated through game theory strategy API 102 that evaluates actions sequences per game theory, such as Tit for Tat, Tit for 2 Tat, etc. In some variations, operation 209 can specify strategies to incorporate from operation 208 and related executive control aspects. Executive control strategies can include parameters resulting from the evaluation of strategies, team-system formation recommendations and prior experience of executive task planners. For example, to achieve a degrade effect, a cyber-attack, if possible, provides a clean execution with minimum casualties. Alternatively, a destroy effect must be a kinetic activity to rule out any reboot or restart of the radar target asset. This step in the specification process allows quality assurance processes to be performed (e.g., a sanity check by experienced personnel). Rankings of the strategies and/or implementation schedules (single event, recurring every day, recurring every week, etc.) can be specified.

A simulated environment can be computer-implemented implemented through a simulation tool that executes the effect-web plan either using discrete event simulation (e.g., Discrete Event Systems [DEVS] formalism, agent-based modeling (NetLogo, Repast, etc.), or tools like Arena, Simio, and Anylogic), continuous system simulation (e.g., mathematical differential equations) or hybrid simulation approaches (that include both discrete and continuous approaches simultaneously). A real environment that may execute an effect-web plan can comprise human-machine system-teams that refine various aspects of effect-web plan before tasks are executed by human-machine teams.

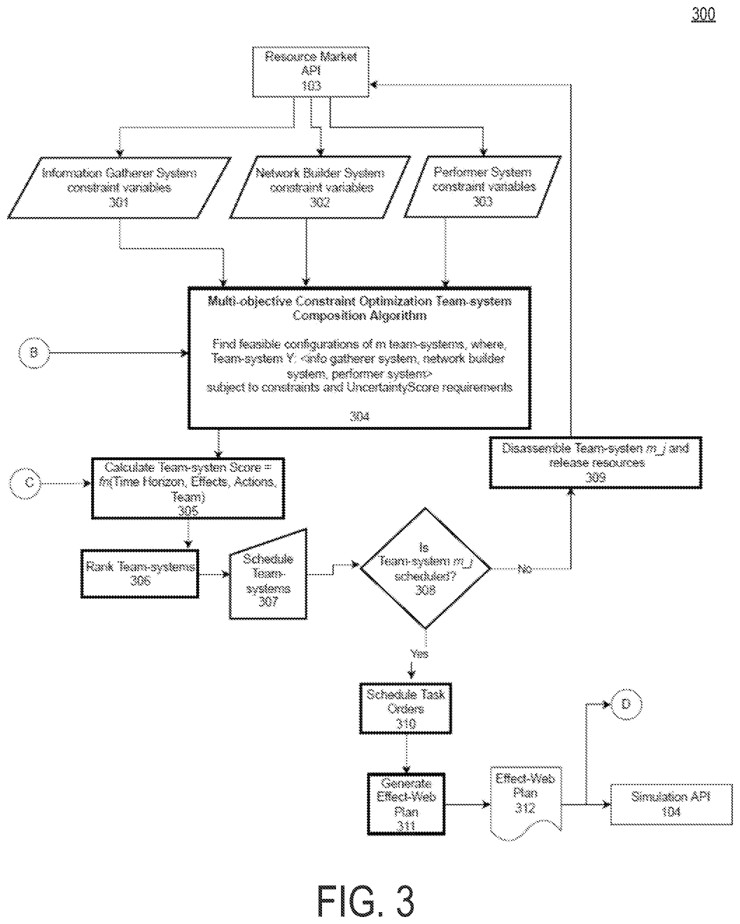

FIG. 3 is a diagram 300 that describes a Multi-Objective Constraint Optimization Team-system Composition (MOCOTeC) algorithm 304 that receives the uncertainty score from operation 208 as requirement specifications to arrive at a team-system configuration while satisfying, for example, three type of constraints: information gatherer system constraints 301, network builder system constraints 302 and performer system constraints 303, to produce an executable effect-web plan. Information gatherer systems can be sensor systems that obtain data characterizing the entity and the frequency of data collection (e.g., continuous, seconds, minutes, hours, days, etc.). Constraints on the information gatherer systems can also be defined (for example, their sampling rate, their operational thresholds, data formats, communication channels, etc.). The network builder systems that are available (i.e., the set of systems that provide communication and control mechanisms to influence EnSVs) can be identified. These systems may be operating at different frequencies (e.g., continuous, seconds, minutes, hours, days, etc.). Some examples of network builder systems include mobile sensors or drones that provide hub-like functionality to create dynamic communication networking, coordination, and control to connect owner resources dynamically. Constraints on the network builder systems can also be defined, for example, network communication protocol, window of availability, interoperability mechanisms, time to setup, etc. In addition, available performer systems can be identified (i.e., a set of systems that produce an effect to indirectly influence EnSVF(xj) range values. These systems can also be operable at different frequencies (e.g., continuous, seconds, minutes, hours, days, etc.). For example, performers can be owner assets that can produce a cyberattack disrupting an entity's operation or a kinetic/physical attack that destroys the entity asset completely. Constraints on the performers can also be defined, such as time of availability, time of scheduling, success probability, power capacity, etc. These three types of resources can be accessible through resource market API 103 that notifies of available resources and applicable constraints within a given time horizon. The objective functions and/or utilized machine learning models used by the MOCOTeC algorithm can optimize team-system configuration for criteria like time horizons, fewest number of actions, minimum number of effects, availability of at least two effects in effect-web and the like. These multiple criteria for a given resource system can be aggregated in a reliability score for that resource. Various team configurations in 304 can then be scored, at 305, and aligned with a suggested game theory strategy API 102 recommendation identified in 209. The scored teams can be optimal solutions to the MOCOTeC algorithm subject to different optimization criteria. The optimization can be based on identifying team configurations with high reliability scores for network builder system, information gatherer system and performer system taken together and associated with the earlier identified uncertainty risk score for a given time horizon. The pareto optimal solutions can be gathered from two categories, viz., (high reliability, low risk) and (high reliability, high risk), among the four team-system reliability and risk pairing categories. For example, while an ideal (team-system configuration) solution with high reliability and low risk has a higher probability of delivering a successful effect, a solution with high reliability and high risk may get selected in adverse circumstances. Another category for low reliability, low risk can be further considered for any experimental activity, if the situation so warrants. This step leads to ranking of team-system configurations at 306 followed by scheduling of ranked teams at 307 through manual input. If the team-system can be successfully scheduled at 308 due to availability of team-system participants, task orders can be computationally created involving a combination of sequential and parallel arrangements subject to participant system's availability constraints. Tasks are scheduled for the given time horizon, at 310, otherwise, the team-system is disassembled and released back to the resource market API 103. The scheduled task orders are aligned with the corresponding effects at 311 to generate an effect-web plan 312. The plan is then put to execution in a simulated or real environment.

The effect-web plan in 312 is of the structure/schema, constituting, for example, a matrix with columns: time horizon, echelon level specifying authority over resources in a team-system configuration, resource availability, EnSVF(x,j) domain values, effect specifications, EnSVF(x,j) range values, team configuration and/or task orders. Other elements can be utilized depending on the desired configuration fidelity. For an executable effect-web plan, the matrix will have at least two rows indicating at least two effects within an effect-web, where each row is an instantiation of a team-system configuration and related information in other columns tasked to deliver the effect. As noted above, an effect-web can be defined as a confluence of multiple effects to influence CoSV in more than one way.

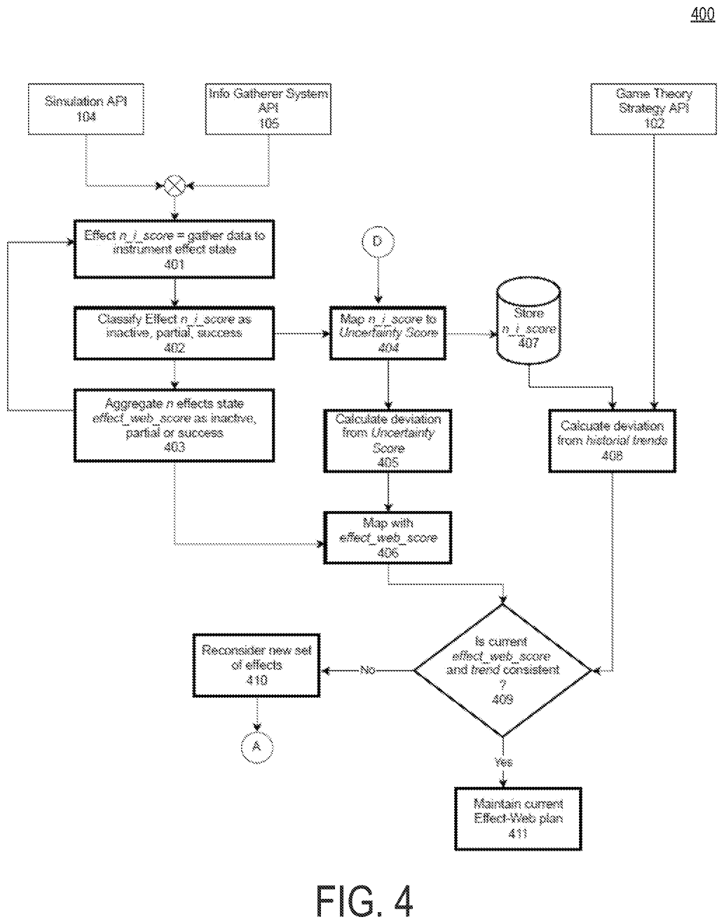

FIG. 4 is a diagram 400 that describes an architecture and method for controlling the effect-web and tracking uncertainty risk score once a team-system configuration starts executing their tasks in a simulated or real environment. The tracking is done through data arriving from simulation API 104 and information gatherer system API 105. This multi-modal data can arrive at different frequencies (seconds, minutes, hours or days). This data can correspond to various EnSVF(x,j) range variables. The range values can be calculated based on the domain values for each EnSVF(x,j) and its deviation from the expected range value is calculated in “Effect n_i_score” at 401. Qualitatively, no deviation (probability of occurrence p<0.2) from expected range value yields “inactive” effect, a significant deviation (0.2<p<0.8) as “partial” and a large deviation (p>0.8) as “success” effect. The quantified values can be normalized using regression model, fuzzy logic, machine learning logistic regression on EnSVF(x) functions for each effect in 402 and in aggregate for the entire effect-web in 403. Each Effect n_i_score in 402 can also be mapped to uncertainty score in 404 to calculate deviation from uncertainty score in 405, and can be further stored in a database 407 for regression analysis and historical trend analysis in 408. Deviation of each effect from the uncertainty score in 405 can be aggregated to calculate the overall deviation for the effect-web in 406. This deviation and the deviation from historical trend analysis can be merged to quantify the current effect-web performance in 409. The historical data stores information about a team-system's performance and reliability over a period of time in achieving an effect with a specified effect fidelity. Based on different situations, the instrumentation of an effect needs to be normalized with historical data to arrive at an objective assessment of team-system's reliability and uncertainty scores for achieving that effect. This ensures the team-system's and its constituent resource system's performance is evaluated in a non-contextual manner, which is essential to understanding the reliability and uncertainty associated with any give resource system and the resulting team-system to achieve an effect. If both the deviations are in the same positive direction, then the current effect-web plan is to be maintained in 411. If they are both in the same negative direction, the current effect-web plan is to be maintained in 411 as well. If they are in opposite directions, then a new set of effects need to be considered in 410, which eventually notifies the decision maker to reconsider the current effect-web plan in 206.

Further, feasible actions can be defined in 209 and associated tasks in 310 (i.e., actions and tasks that can be taken by a performer to produce an effect). For example, these actions can include operations such as launching a drone sensor swarm for gathering new data feeds, launching a cyberattack, launching physical strikes, etc. The effect(s) can, in some variations, be implemented by a team-system (i.e., a combination of coordinated computing systems and/or computer-implemented processes) comprising a specified configuration of information gatherer systems, performer systems and network builder systems that collectively act to deliver an effect. The actions can be implemented via one or more tasks executed by a performer system.

As noted above, if the effect-web score is not consistent with the historical trend in 409, trajectory needs to be altered, then, at 410, effect-web plan can be created until the desired effect/uncertainty score is obtained. As part of creating effects, available network builder systems that are not constrained along with available performer systems that are not constrained can be identified or otherwise established. As part of the effect-web creation, a dominant game theory strategy can be identified that yields one or more effects within the effect-web. Based on the identified dominant strategy, a new target range for the competitor state variables can be established over different time periods/on different time-bases.

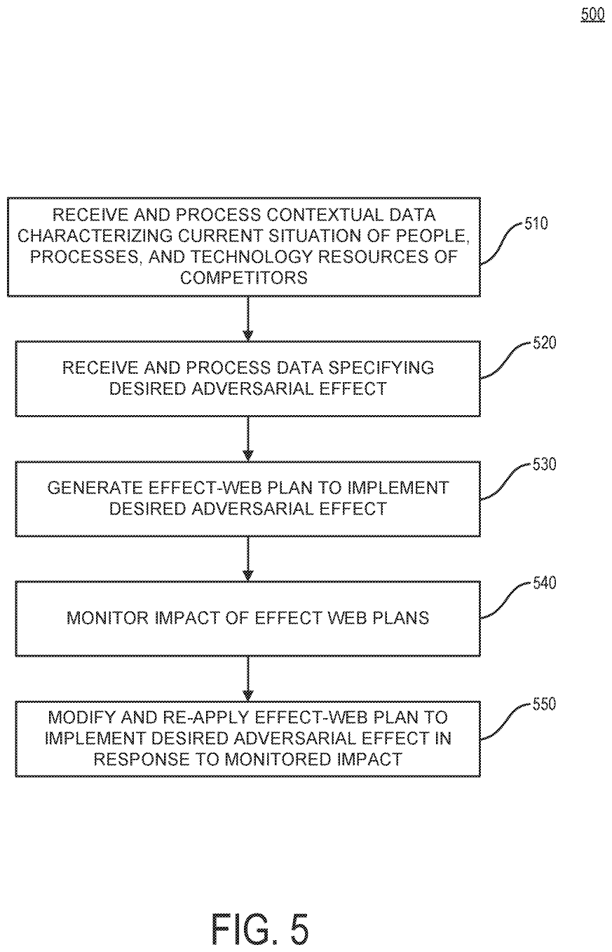

FIG. 5 is a process flow diagram 500 in which, at 510, contextual data is received and processed that characterizes a current state of people, processes, and technology resources of a competitor as multiple situation contexts through various CoSVs. In addition, at 520, data comprising desired adversarial effects against the competitor is received and processed. A computer-implemented effect and uncertainty strategy API generates, at 530, an effect-web plan based on the contextual data and the desired effects requirements. The effect-web plan includes a plurality of effects, actions and task plans to implement the desired adversarial effects. Thereafter, available team-systems to execute the effect-web plan are determined. The generated effect-web plan can be deployed by a selected team-system (e.g., a top ranked team-system, etc.). Data characterizing a multi-order impact of the deployment of the effect-web plan on the entity can, at 540, be monitored. The generated effect-web plan can be modified and deployed, at 550, based on the monitoring so as to increase a likelihood of an occurrence and success of the desired adversarial effects.

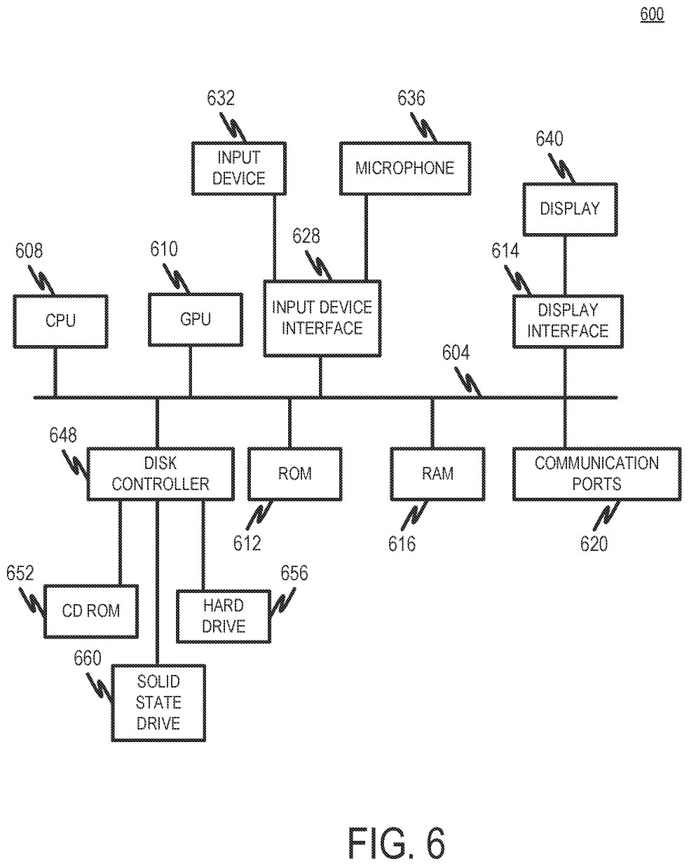

FIG. 6 is a diagram 600 illustrating a sample computing device architecture for implementing various aspects described herein. A bus 604 can serve as the information highway interconnecting the other illustrated components of the hardware. A processing system 608 labeled CPU (central processing unit) (e.g., one or more computer processors/data processors at a given computer or at multiple computers), can perform calculations and logic operations required to execute a program. In addition, a processing system 610 labeled GPU (graphics processing unit) (e.g., one or more computer processors/data processors at a given computer or at multiple computers), can perform calculations and logic operations required to execute a program. A non-transitory processor-readable storage medium, such as read only memory (ROM) 612 and random access memory (RAM) 616, can be in communication with the processing system 608 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 648 can interface with one or more optional disk drives to the system bus 604. These disk drives can be external or internal floppy disk drives such as 660, external or internal CD-ROM, CD-R, CD-RW or DVD, or solid state drives such as 652, or external or internal hard drives 656. As indicated previously, these various disk drives 652, 656, 660 and disk controllers are optional devices. The system bus 604 can also include at least one communication port 620 to allow for communication with external devices either physically connected to the computing system or available externally through a wired or wireless network. In some cases, the at least one communication port 620 includes or otherwise comprises a network interface.

To provide for interaction with a user, the subject matter described herein can be implemented on a computing device having a display device 640 (e.g., a CRT (cathode ray tube) or LCD (liquid crystal display) monitor) for displaying information obtained from the bus 604 via a display interface 614 to the user and an input device 632 such as keyboard and/or a pointing device (e.g., a mouse or a trackball) and/or a touchscreen by which the user can provide input to the computer. Other kinds of input devices 632 can be used to provide for interaction with a user as well; for example, feedback provided to the user can be any form of sensory feedback (e.g., visual feedback, auditory feedback by way of a microphone 636, or tactile feedback); and input from the user can be received in any form, including acoustic, speech, or tactile input. The input device 632 and the microphone 636 can be coupled to and convey information via the bus 604 by way of an input device interface 628. Other computing devices, such as dedicated servers, can omit one or more of the display 640 and display interface 614, the input device 632, the microphone 636, and input device interface 628.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving and processing contextual data characterizing a current state of resources of an entity;
receiving and processing data comprising desired adversarial effects against the entity;
generating, by a computer-implemented effect and uncertainty strategy application programming interface (API) based on the contextual data and desired effects requirements, an effect-web plan comprising a plurality of effects, actions and task plans to implement the desired adversarial effects;
determining available team-systems to execute the effect-web plan;
causing the generated effect-web plan to be deployed by a selected team-system;
monitoring data characterizing multi-order impact of the deployment of the effect-web plan on the competitor; and
modifying and deploying the generated effect-web plan based on the monitoring to increase a likelihood of an occurrence and success of the desired adversarial effects.

2. The method of claim 1, wherein the resources of the entity comprise one or more of: people, processes and technology resources of the entity.

3. The method of claim 1, wherein the team-systems comprise an ensemble of information gatherer systems, network builder systems and performer systems.

4. The method of claim 1, the generated effect-web plan is deployed as part of a computer-implemented simulation.

5. The method of claim 1, wherein the available team-systems are determined using a multi-objective constraint optimization algorithm.

6. The method of claim 1, wherein the available team-systems are ranked using one or more machine learning models.

7. The method of claim 1, wherein the contextual data comprises competitor identification and state data.

8. The method of claim 1, wherein the contextual data comprises executive strategy data.

9. The method of claim 1, wherein the contextual data is received from one or more of a gatherer system data feed, a network builder system, or a performer system. data.

10. The method of claim 1, wherein the contextual data comprises simulation

11. The method of claim 1 further comprising:
deploying a plurality of sensors to obtain the contextual data.

12. The method of claim 11, wherein at least a portion of the sensors comprise hardware-based sensors including a processor and memory.

13. The method of claim 11, wherein at least a portion of the sensors comprise software-based sensors configured to obtain data and synthesize contextual data from differing data sources.

14. The method of claim 11, wherein the plurality of sensors further provides the monitored data for effect instrumentation.

15. The method of claim 1, wherein the received contextual data comprises competitor state variables, wherein the generation of the effect-web plan comprises:
applying game theory to specify one or more computer-implemented identified actions to evaluate the competitor state variables operating within a pre-defined range.

16. The method of claim 1, wherein the effect-web plan is generated so as to influence a subset of the competitor state variables comprising end-state variables.

17. The method of claim 16, wherein effects deployed by the effect-web plan cause one or more of the end-state variables to change over time in a desired direction as a quantified through an uncertainty score.

18. The method of claim 3 further comprising:
iteratively matching constraints applicable to the information gatherer systems, performer systems and/or network builder systems within the team-system to formulate new tasks and schedules to deploy the team-system configuration in a simulated or real environment.

19. The method of claim 18 further comprising:
establishing control on uncertainty associated with end-state variables, wherein at least one of the deployed effects targets the competitor state variables having the associated uncertainty in an operating range of the competitor state variables.

20. The method of claim 1 further comprising:
ranking the available team-systems; and
wherein the selected team is a top ranked team.

21. A system comprising:
at least one data processor; and
memory storing instructions which, when executed by the at least one data processor, result in operations comprising:
receiving and processing contextual data characterizing a current state of people, processes, and technology resources of an entity;
receiving and processing data comprising desired adversarial effects against the entity;
generating, by a computer-implemented effect and uncertainty strategy application programming interface (API) based on the contextual data and desired effect-web requirements, an effect-web plan comprising a plurality of effects, actions and task plans to implement the desired adversarial effects;
determining available system of system (SoS) human, machine or human-machine team-systems to execute the effect-web plan;
causing the generated effect-web plan to be deployed by a top ranked SoS team-system; and
monitoring data characterizing multi-order impact of the deployment of the effect-web plan on the entity; and
modifying and deploying the generated effect-web plan based on the monitoring to increase a likelihood of an occurrence of the desired adversarial effects.

22. The system of claim 21 further comprising:
a plurality of information gatherer systems;
a plurality of network builder systems; and
a plurality of performer systems.

23. The system of claim 22, wherein the operations further comprise:
iteratively matching constraints applicable to the information gatherer systems, performer systems and/or network builder systems within the team-system to formulate new tasks and schedules to deploy the team-system configuration in a simulated or real environment.

24. The system of claim 23, wherein the operations further comprise:
establishing control on uncertainty associated with end-state variables, wherein at least one of the deployed effects targets the competitor state variables having the associated uncertainty in an operating range of the competitor state variables.
